(19) United States
(12) Patent Application Publication
(10) Pub. No.: US 2005/0207686 A1
(43) Pub. Date: Sep. 22, 2005

(54) Split bushing

(76) Inventor: Marcel Thibault, Mont St-Hilaire (CA)

Correspondence Address: Eric Fincham, 316 Knowlton Road, Lac Brome, J0E 1V0, CA

(21) Appl. No.: 10/806,760

(22) Filed: Mar. 22, 2004

(51) Int. Cl. F16C 33/02; F16C 33/74

(52) U.S. Cl. 384/301

(57) ABSTRACT

A split bushing having first and second ends and formed first and second portions, each of the first and second portions having first ends which have a circumference which is less than 50% of the total bushing first end circumference and a second end with a circumference which is greater than 50% of the total bushing second end circumference. The first end of the first portion the second end of the second portion formed a first end of the bushing. The bushing is easily inserted and removed as required.

### FIELD OF THE INVENTION

The present invention relates to bushings and more particularly, relates to a split bushing.

### BACKGROUND OF THE INVENTION

Bushings are well known in the art and are widely used. As such, there are many different numbers of different types of bushings. The particular bushing design will depend upon the end use of the same. Thus, a standard configuration is a bushing having a cylindrical body with end flanges thereon. This type of bushing is suitable for many purposes save and except when the bushing must be inserted into another member.

There are also bushings which are formed of two pieces at either end, with the pieces each having a flange and being held in place by suitable means.

It is also known to use tapered bushings which must fit within a member. Likewise, it is also been proposed in the art to use a bushing which has a radial split.

While such above described bushings are suitable for many uses, there still remains a requirement for a bushing which can be inserted into a second member and which will not loosen or move when longitudinal movement of the member is required.

### SUMMARY OF THE INVENTION

According to one aspect of the present invention, there is provided a split bushing having a first end and a second end, comprising first and second portions, each of the first and second portions having a first and second end, a first end of each of the portions having a circumference which is less than 50% of the total bushing first end circumference, the second end of each of the portions having a circumference which is greater than 50% of the total bushing second end circumference, the arrangement being such that the first end of the first portion and the second end of the second portion form the first end of the bushing, and the second end of first portion and the first end of the second portion form the second end of the bushing.

According to a further aspect of the present invention, in an apparatus having a bushing with a rod passing therethrough, there is provided the improvement wherein the bushing is a split bushing having a first end and a second end, comprising first and second portions, each of the first and second portions having a first and second end, a first end of each of the portions having a circumference which is less than 50% of the total bushing first end circumference, the second end of each of the portions having a circumference which is greater than 50% of the total bushing second end circumference, the arrangement being such that the first end of the first portion and the second end of the second portion form the first end of the bushing, and the second end of first portion and the first end of the second portion form the second end of the bushing.

As aforementioned, the present bushing is formed of two portions, each of the portions being similar. The bushing is designed to be inserted into a receiving member and to be retained therein.

The bushing is fabricated of somewhat resilient material such as various types of plastics including polyvinyl, polypropylene, etc.

Each of the two portions has a central body section and a flange, extending outwardly at either end thereof. Each of the portions is characterized in that the end walls at the first and second ends are sized differently—i.e. a first end wall has a circumferential length which is less than 50% of the total bushing circumference while at the other end, the second end wall has a circumference which is greater than the 50% of the total bushing circumference. The two portions are placed in an opposing relationship such that they form substantially 100% of the bushing circumference.

### BRIEF DESCRIPTION OF THE DRAWINGS

Having thus generally described the invention, reference will be made to the accompanying drawings illustrating an embodiment thereof, in which:

FIG. 1 is a perspective view of a bushing according to one embodiment of the present invention;

FIG. 2 is an exploded view illustrating the two portions forming the bushing;

FIG. 3 is a first end elevational view thereof;

FIG. 4 is a side elevational view thereof;

FIG. 5 is a second end elevational view thereof;

FIG. 6 is an end elevational view illustrating placement of the bushing in a receiving member;

FIG. 7 is a top plan view of the arrangement of FIG. 6;

FIG. 8 is an end elevational view of the inserted bushing.

### DESCRIPTION OF THE PREFERRED EMBODIMENTS

Referring to the drawings in greater detail and by reference characters thereto, there is illustrated in FIG. 1 an assembled bushing which is designated by reference numeral 10.

Bushing 10 includes a first portion generally designated by reference numeral 12 and a second portion generally designates by reference numeral 14.

First portion 12, as may be seen in Figures, includes a central body section 16 which has a first end generally designated by reference numeral 18. Located at first end 18 is a flange 20 extending outwardly therefrom. A second end of first portion 12 is generally designated by reference numeral 22 and in an manner similar to first end 18, has an outwardly extending flange 24. Extending between first end 18 and second end 22 are sidewalls 26 and 28.

Second portion 14 also includes a central body section 32 which has a first end 34. Located at first end 34 is an outwardly extending flange 36. Similarly, a second end generally designated by reference numeral 38 also has an outwardly extending flange 40. Extending between first end 34 and second end 38 are sidewalls 42 and 44.

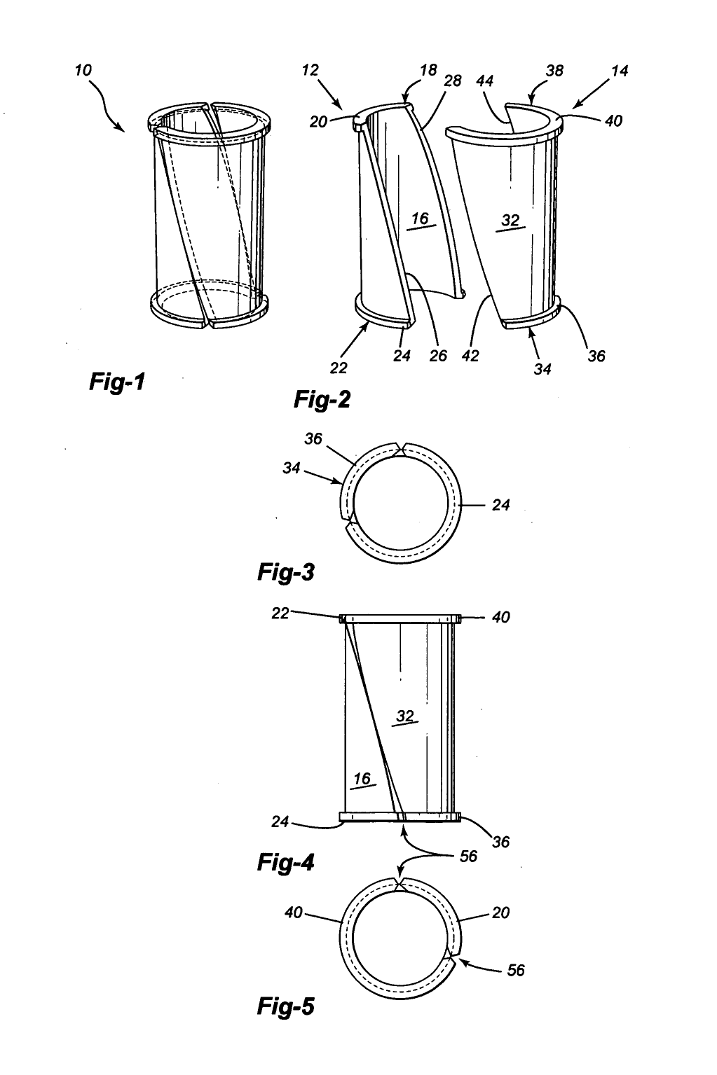

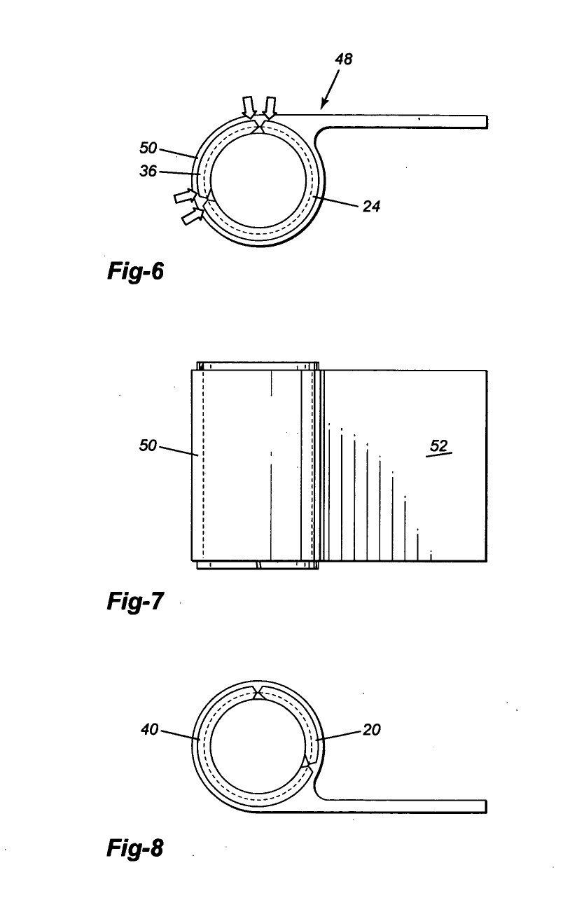

As may be clearly seen in FIGS. 2, 3 and 5, first ends 18 and 34 of portion 12 and 14 respectively each have a relatively small circumference—i.e. less than 50% of the total circumference of the bushing end. Similarly, second ends 22 and 38 each have a circumference which is greater then 50% of the total end circumference. It will also be noted that sidewalls 26, 28 and 42, 44 are somewhat accurate in the configuration and shape such had when first portion 12 and second portion 14 are assembled, there is a slot 56 formed at the respective ends. In the central portion, the sidewalls 26 and 42 abut each other for a portion of their length as do sidewalls 28 and 44.

The above arrangement permits the insertion of the bushing in a holder 48 as shown in FIG. 6. Holder 48 has a cylindrical housing 50 and a flange 52.

Preferably, as previously discussed, the smaller ends 18 and 34 preferably have a circumferential length which is between 20% and 35% of the total circumference of the bushing and even more preferably, between about 25% and about 30% of the total circumferential length.

It will be understood that the above described embodiment is for purposes of illustration only and the changes and modifications may be made thereto without the party from the spirit and scope of the invention.

1. A split bushing having a first end and a second end, comprising first and second portions, each of said first and second portions having a first and second end, a first end of each of said portions having a circumference which is less than 50% of the total bushing first end circumference, said second end of each of said portions having a circumference which is greater than 50% of the total bushing second end circumference, the arrangement being such that said first end of said first portion and said second end of said second portion form said first end of said bushing, and said second end of first portion and said first end of said second portion form said second end of said bushing.

2. The split bushing of claim 1 wherein said first end of each said first and second portions has a circumferential length which is between 20% and 35% of a total circumferential length.

3. The split bushing of claim 2 wherein said circumferential length of each said first ends is between 25% and 30% of said total circumferential length.

4. The split bushing of claim 2 wherein said bushing is formed of a plastics material.

5. The split bushing of claim 4 wherein said plastics material is a polyvinyl chloride.

6. The split bushing of claim 2 wherein each of said first and second portions has first and second sidewalls extending between respective first and second ends, each of said sidewalls having a generally accurate configuration.

7. The split bushing of claim 2 wherein each of said ends has an outwardly extending flange therefrom to retain said bushing in a holder.

8. In an apparatus having a bushing with a rod passing there through, the improvement wherein said bushing is a split bushing having a first end and a second end, comprising first and second portions, each of said first and second portions having a first and second end, first end of each of said portions having a circumference which is less than 50% of the total bushing first end circumference, said second end of each of said portions having a circumference which is greater than 50% of the total bushing second end circumference, the arrangement being such that said first end of said first portion and said second end of said second portion form said first end of said bushing, and said second end of first portion and said first end of said second portion form said second end of said bushing.

9. The improvement of claim 8 wherein each of said first end of each of said first and second portions has a circumferential length which is between 20% and 35% of a total circumferential length.
